(19) United States
(12) Patent Application Publication
(10) Pub. No.: US 2005/0146878 A1
(43) Pub. Date: Jul. 7, 2005

(54) Illuminable three-dimensional shape

(76) Inventor: Scot Williams, Oxnard, CA (US)

Correspondence Address: TOPE-MCKAY & ASSOCIATES, 23852 PACIFIC COAST HIGHWAY #311, MALIBU, CA, 90265, US

(21) Appl. No.: 10/752,103

(22) Filed: Jan. 5, 2004

(51) Int. Cl. F21V 33/00

(52) U.S. Cl. 362/257

(57) ABSTRACT

A decorative shape, and more particularly, an illuminable three-dimensional shape having an illuminable translucent three-dimensional environment for receiving light from a light source, and a three-dimensional form interacting with the illuminable three-dimensional environment are presented. The combination of the illuminable translucent three-dimensional environment, the three-dimensional form, and the light received from the light source causes the three-dimensional form to appear as if it is interacting with the illuminable translucent three-dimensional environment.

### FIELD OF INVENTION

The present invention relates to a decorative shape, and, more particularly, to an illuminable three-dimensional shape having an illuminable translucent three-dimensional environment for receiving light from a light source and a three-dimensional form interacting with the illuminable three-dimensional environment.

### BACKGROUND OF INVENTION

Decorative shapes have long been known in prior art. With conception of moldable translucent materials, illuminating properties have been incorporated into many illuminable shapes.

Although traditional decorative shapes may be illuminable, an illuminating light does not distinguish between a three-dimensional environment and a three-dimensional form interacting with the environment. Through distinguishing between the environment and the form, the illuminating properties will cause the form to appear to be interacting with the environment, thereby creating a sense of realism in the decorative shape.

Therefore, it can be appreciated that there exists a continuing need for a three-dimensional illuminable shape wherein when illuminated, a light source causes the three-dimensional form to appear as if it is interacting with an illuminable translucent three-dimensional environment. The present invention substantially fulfills this need.

### SUMMARY OF INVENTION

The present invention relates to a decorative shape, and more particularly, to an illuminable three-dimensional shape. The illuminable three-dimensional shape comprises an illuminable translucent three-dimensional environment for receiving light from a light source and a three-dimensional form attached with the illuminable three-dimensional environment, such that when the light source lights the environment, the environment is illuminated, and a combination of the illuminable translucent three-dimensional environment, the three-dimensional form, and light received from the light source causes the three-dimensional form to appear as if it is interacting with the illuminable translucent three-dimensional environment.

In another aspect, the three-dimensional form is an opaque three-dimensional form.

In yet another aspect, the illuminable three-dimensional shape further comprises a base attached with the illuminable translucent three-dimensional environment. Additionally, the base houses an electrical source to provide power to the light source in order to illuminate the illuminable translucent three-dimensional environment. The light source is an LED light inserted into the illuminable translucent three-dimensional environment in order to illuminate the illuminable translucent three-dimensional environment.

In another aspect, the three-dimensional form is an athlete and is selected from a group consisting of a surfer, a rock climber, a skier, a snowboarder, a skateboarder, an extreme biker, a backpacker, a roller-blader, a volleyball player, and a basketball player.

Additionally, the illuminable three-dimensional environment is an environment selected from a group consisting of a wave, a rock face, snow, a ramp, a mountain, a sidewalk, a street, a volleyball court, and a basketball court.

In another aspect, a combination of the athlete and the illuminable three-dimensional environment is selected from a group consisting of a surfer with a wave, a rock climber with a rock face, a skier with snow, a snowboarder with snow, a skateboarder with a ramp, an extreme biker with a ramp, a backpacker with a mountain, a roller-blader with a ramp, a roller-blader with a sidewalk, a volleyball player with a volleyball court, and a basketball player with a basketball court.

In yet another aspect, the light source includes a rotating color system, configured so that when activated, a color of the light source changes from one color into another color, thereby illuminating the illuminable translucent three-dimensional environment with another color.

Additionally, the illuminable three-dimensional shape further comprises a means for storing and reproducing a sound stored therein, where the sound being produced corresponds to a theme of the combination of the athlete and the illuminable three-dimensional environment, thus correlating audio data stored in the illuminable three-dimensional shape with the theme.

Furthermore, the illuminable three-dimensional shape further comprises an alarm clock incorporated therein with an alarm sound corresponding to a theme of the combination of the athlete and the illuminable three-dimensional environment, whereby when the alarm clock is actuated and an alarm is activated, the sound being produced corresponds with the theme.

In yet another aspect, the illuminable three-dimensional shape further comprises a theft prevention device attached with the base. The theft prevention device further comprises a light sensor attached with the base, with an alarm operably connected with the light sensor. The light sensor is positioned on the base such that when the base is placed upon an opaque surface, the light sensor does not receive any light from a surrounding environment. However, where when the base is removed from the opaque surface, the light sensor detects environmental light and activates the alarm, thereby aiding in prevention of theft of the illuminable three-dimensional shape.

### BRIEF DESCRIPTION OF THE DRAWINGS

The nature of the illuminable three-dimensional shape described herein will be readily apparent in the following drawings, in which:

FIG. 1 is a left side perspective view of an illuminable three-dimensional shape according to the present invention;

FIG. 2A is a top view of the illuminable three-dimensional shape of FIG. 1;

FIG. 2B is a top view of a base, cut-away to show an interior of the base;

FIG. 2C is a left side perspective view of a base;

FIG. 2D is a left side perspective view of an unassembled base;

FIG. 3 is a left side perspective view of an illuminable three-dimensional shape according to the present invention, with a clock incorporated therein;

FIG. 4A illustrates another aspect of the present invention, where the light source includes a rotating color system; and

FIG. 4B illustrates another aspect of the present invention, where the illuminable three-dimensional shape further comprises a theft prevention device incorporated therein.

### DETAILED DESCRIPTION

The present invention relates to a decorative shape, and more particularly, to an illuminable three-dimensional shape having an illuminable translucent three-dimensional environment for receiving light from a light source, and a three-dimensional form interacting with the illuminable three-dimensional environment.

The following description, taken in conjunction with the referenced drawings, is presented to enable one of ordinary skill in the art to make and use the invention. Various modifications will be readily apparent to those skilled in the art, and the general principles defined herein may be applied to a wide range of aspects. Thus, the present invention is not intended to be limited to the aspects presented, but is to be accorded the widest scope consistent with the principles and novel features disclosed herein. Furthermore it should be noted that unless explicitly stated otherwise, the figures included herein are illustrated diagrammatically and without any specific scale, as they are provided as qualitative illustrations of the concept of the present invention.

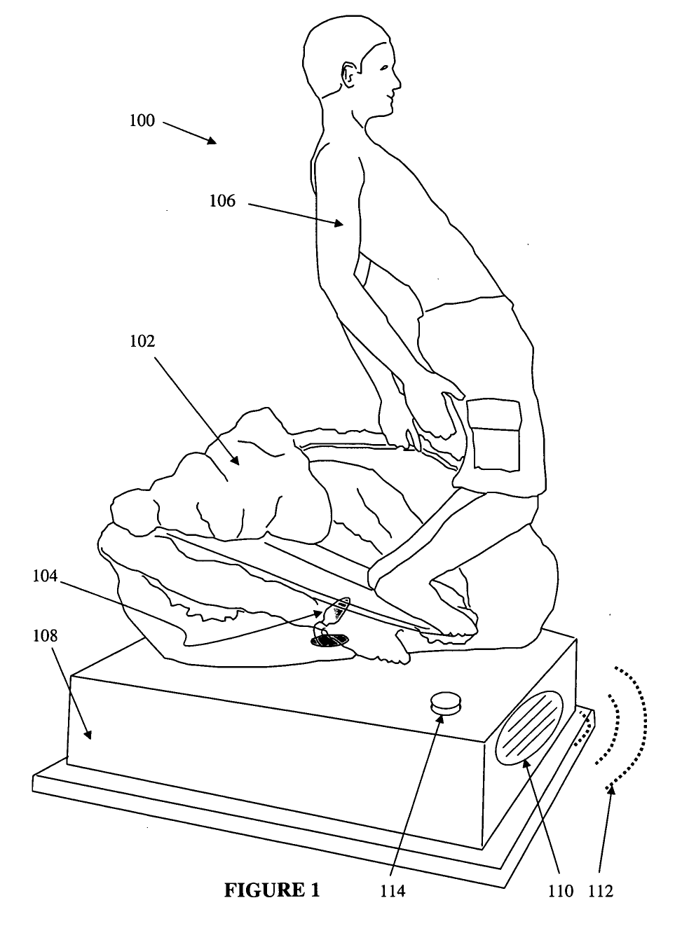

FIG. 1 illustrates an illuminable three-dimensional shape 100 according to the present invention. The shape 100 includes an illuminable translucent three-dimensional environment 102 for receiving light from a light source 104. The environment 102 may be constructed of any suitably translucent material, non-limiting examples of which include plastic and glass. Additionally, the light source 104 may be any suitable mechanism or device for emitting light, a non-limiting example of which includes a light-emitting diode (LED) light). Further, the light source 104 may be inserted into the environment 102 in order to illuminate it, or alternatively, positioned on an exterior of the environment 102.

Interacting with the environment 102 is a three-dimensional form 106. The three dimensional form 106 is constructed of any suitably rigid material, non-limiting examples of which include plastic, metal, and glass. The three-dimensional form 106 may be opaque and prevent the transmission of light, or translucent and thereby illuminable. When the light source 104 illuminates the environment 102, a combination of the environment 102, the three-dimensional form 106, and light received from the light source, causes the three-dimensional form 106 to appear as if it is interacting with the environment 102.

The three-dimensional form 106 may be any suitable form, non-limiting examples of which include an athlete and a marine animal. When the three-dimensional form is an athlete, the athlete is any suitable athletic figure, non-limiting examples of which include a surfer, a rock climber, a skier, a snowboarder, a skateboarder, an extreme biker, a backpacker, a roller-blader, a volleyball player, and a basketball player. The environment 102 is selected such that it corresponds with the three-dimensional form 106, non-limiting examples of which include a surfer with a wave, a rock climber with a rock face, a skier with snow, a snowboarder with snow, a skateboarder with a ramp, an extreme biker with a ramp, a backpacker with a mountain, a roller-blader with a ramp, a roller-blader with a sidewalk, a volleyball player with a volleyball court, and a basketball player with a basketball court.

When the three-dimensional form 106 is a marine animal, the marine animal is any suitable marine animal, of which non-limiting examples include a fish, a whale, a dolphin, and a seal. As is the case with the athlete, the environment 102 is selected such that it corresponds with the three-dimensional form 106, where non-limiting examples of which include a fish with plants, a whale with waves, a dolphin with waves, a seal on a rock, a seal on a beach, and a whale with ice.

The shape 100 also includes a base 108. The base 108 is constructed of any suitably rigid material, non-limiting examples of which include plastic, glass and metal. The base 108 houses an electrical source to provide power to the light source 104 in order to illuminate the shape 100.

The shape 100 may also include a means for storing and reproducing a sound stored therein. The means for storing and reproducing a sound may be any suitable sound storing and reproducing device or mechanism, non-limiting examples include a memory chip attached with a speaker 110. In this aspect, the sound 112 being produced corresponds to a theme of the combination of the athlete 106 and the illuminable three-dimensional environment 102, thus correlating audio data stored in the illuminable three-dimensional shape 100 with the theme. For example, when the athlete 106 is a surfer and the environment 102 is a wave, the sound 112 may repeat the words, “Wipe Out” or simply be the sound of a crashing wave. The sound 112 is activated through any suitable mechanism or device for completing an electrical circuit. For example, the sound 112 may be activated upon depression of a button 114, or alternatively, when the shape 100 is illuminated. In another aspect, a noise activation device may be attached with the means for storing and reproducing a sound, such that the sound 112 is noise activated.

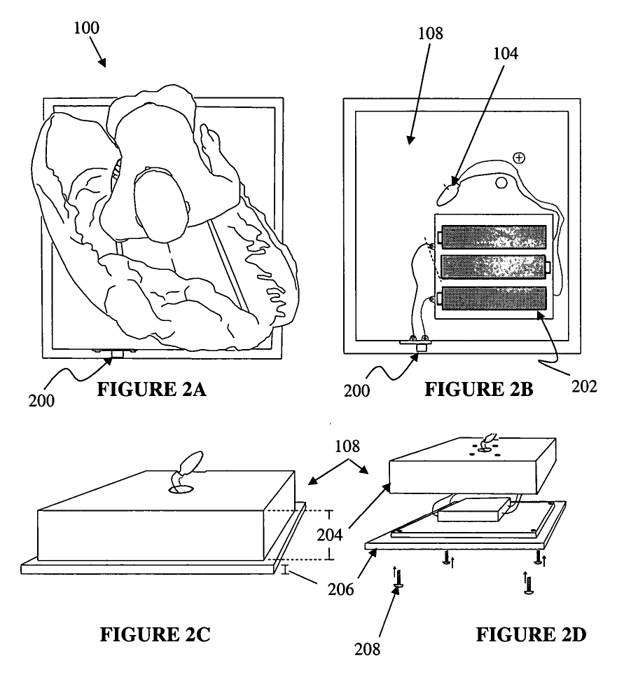

FIG. 2A illustrates a top view of the shape 100. In order to illuminate the shape 100, a user must activate the light source through use of an activator 200. The activator 200 may be any suitable mechanism or device for completing an electrical circuit, non-limiting examples of which include a button and a switch.

FIG. 2B illustrates an interior of a base 108. As illustrated, the base 108 houses an electrical source 202. Through use of the activator 200, the electrical source 202 provides power to the light source 104. The electrical source 202 may be any suitable power supply, non-limiting examples of which include batteries and an electrical power cord.

FIG. 2C illustrates an assembled base 108. As shown in this illustration, the base 108 may be comprised of two parts, a top portion 204 and a bottom portion 206.

FIG. 2D illustrates an unassembled base 108. In this aspect, the top portion 204 functions as a housing and the bottom portion 206 is attached with the top portion 204 through a fastener 208. The fastener 208 may be any suitable apparatus or device for affixing one object with another, non-limiting examples of which include screws and glue.

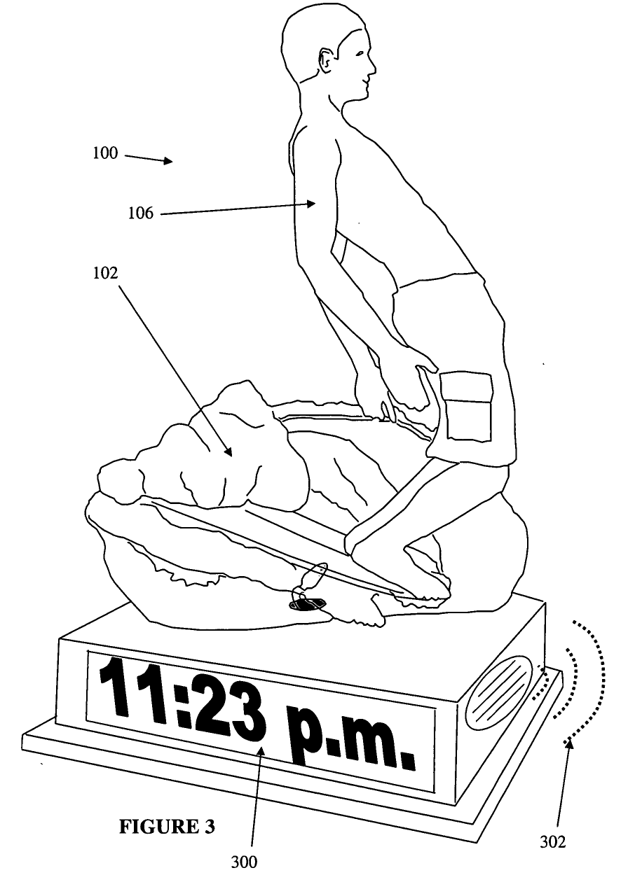

FIG. 3 illustrates another aspect of an illuminable three-dimensional shape 100 according to the present invention. In this particular aspect, a clock 300 is incorporated therein. The clock 300 may be any suitable mechanism or device for maintaining an accurate representation of time, a non-limiting example of which includes a digital alarm clock. As is well known in the art, alarm clocks are often accompanied by a buzzer or alarm sound 302. In this particular aspect, the alarm sound 302 may be any suitable sound for alerting an individual of a particular time, a non-limiting example of which includes a sound corresponding to a theme of a combination of the athlete 106 and the illuminable three-dimensional environment 102, whereby when the alarm clock 300 reaches an alarm time, an alarm is activated and the alarm sound 302 being produced corresponds with the theme. For example, when the athlete 106 is a surfer and the environment 102 is a wave, the alarm sound 302 may repeat the words, “Surfs Up!”

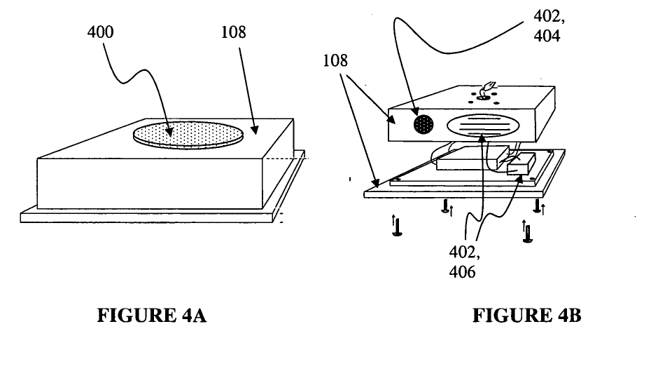

FIG. 4A illustrates another aspect the present invention. In this aspect, the light source includes a rotating color system 400. The rotating color system 400 may be any suitable mechanism or device to change a color emitted from a light source from one color into another color, a non-limiting example of which includes a color wheel. As shown in this particular illustration, the rotating color system may be affixed with the base 108. When the rotating color system 400 is activated, a color of the light source changes from one color into another color, thereby illuminating the illuminable translucent three-dimensional environment with another color.

FIG. 4B illustrates another aspect of the present invention, where the shape further comprises a theft prevention device 402 incorporated therein. The theft prevention device 402 may be incorporated into any suitable location of the shape. For example, the theft prevention device 402 may be incorporated into the base 108. The theft prevention device 402 may be any suitable mechanism or device operating as an activated alarm, a non-limiting example of which includes a light sensor 404 and an alarm 406 operably connected with the light sensor 402. In this aspect, when the light sensor 404 is activated, the alarm 406 is sounded to aid in preventing a theft of the illuminable three-dimensional shape.

1. An illuminable three-dimensional shape, comprising:
an illuminable translucent three-dimensional environment for receiving light from a light source; and
a three-dimensional form attached with the illuminable three-dimensional environment, such that when the light source lights the environment, the environment is illuminated, and a combination of the illuminable translucent three-dimensional environment, the three-dimensional form, and light received from the light source causes the three-dimensional form to appear as if it is interacting with the illuminable translucent three-dimensional environment.

2. An illuminable three-dimensional shape as set forth in claim 1, wherein the three-dimensional form is an opaque three-dimensional form.

3. An illuminable three-dimensional shape as set forth in claim 2, wherein the illuminable three-dimensional shape further comprises a base attached with the illuminable translucent three-dimensional environment.

4. An illuminable three-dimensional shape as set forth in claim 3, wherein the base houses an electrical source to provide power to the light source in order to illuminate the illuminable translucent three-dimensional environment.

5. An illuminable three-dimensional shape as set forth in claim 4, wherein the light source is a LED light inserted into the illuminable translucent three-dimensional environment in order to illuminate the illuminable translucent three-dimensional environment.

6. An illuminable three-dimensional shape as set forth in claim 5, wherein the three-dimensional form is an athlete.

7. An illuminable three-dimensional shape as set forth in claim 6, wherein the athlete is selected from a group consisting of a surfer, a rock climber, a skier, a snowboarder, a skateboarder, an extreme biker, a backpacker, a roller-blader, a volleyball player, and a basketball player.

8. An illuminable three-dimensional shape as set forth in claim 7, wherein the illuminable three-dimensional environment is an environment selected from a group consisting of a wave, a rock face, snow, a ramp, a mountain, a sidewalk, a street, a volleyball court, and a basketball court.

9. An illuminable three-dimensional shape as set forth in claim 8, wherein a combination of the athlete and the illuminable three-dimensional environment is selected from a group consisting of a surfer with a wave, a rock climber with a rock face, a skier with snow, a snowboarder with snow, a skateboarder with a ramp, an extreme biker with a ramp, a backpacker with a mountain, a roller-blader with a ramp, a roller-blader with a sidewalk, a volleyball player with a volleyball court, and a basketball player with a basketball court.

10. An illuminable three-dimensional shape as set forth in claim 9, wherein the light source includes a rotating color system, configured so that when activated, a color of the light source changes from one color into another color, thereby illuminating the illuminable translucent three-dimensional environment with another color.

11. An illuminable three-dimensional shape as set forth in claim 10, wherein the illuminable three-dimensional shape further comprises a means for storing a sound and reproducing the sound stored therein, where the sound being produced corresponds to a theme of the combination of the athlete and the illuminable three-dimensional environment, thereby correlating audio data stored in the illuminable three-dimensional shape with the theme.

12. An illuminable three-dimensional shape as set forth in claim 11, wherein the illuminable three-dimensional shape further comprises an alarm clock incorporated therein having an alarm sound corresponding to a theme of the combination of the athlete and the illuminable three-dimensional environment, whereby when the alarm clock is actuated and an alarm is activated, the sound produced corresponds with the theme.

13. An illuminable three-dimensional shape as set forth in claim 12, wherein the illuminable three-dimensional shape further comprises a theft prevention device attached with the base.

14. An illuminable three-dimensional shape as set forth in claim 13, wherein the theft prevention device further comprises a light sensor attached with the base, with an alarm operably connected with the light sensor, where the light sensor is positioned on the base such that when the base is placed upon an opaque surface, the light sensor does not receive any light from a surrounding environment, and where when the base is removed from the opaque surface, the light sensor detects environmental light and activates the alarm, thereby aiding in prevention of theft of the illuminable three-dimensional shape.

15. An illuminable three-dimensional shape as set forth in claim 1, wherein the illuminable three-dimensional shape further comprises a base attached with the illuminable translucent three-dimensional environment.

16. An illuminable three-dimensional shape as set forth in claim 15, wherein the base houses an electrical source to provide power to the light source in order to illuminate the illuminable translucent three-dimensional environment.

17. An illuminable three-dimensional shape as set forth in claim 15, wherein the illuminable three-dimensional shape further comprises a theft prevention device attached with the base.

18. An illuminable three-dimensional shape as set forth in claim 17, wherein the theft prevention device further comprises a light sensor attached with the base, with an alarm operably connected with the light sensor, where the light sensor is positioned on the base such that when the base is placed upon an opaque surface, the light sensor does not receive any light from a surrounding environment, and where when the base is removed from the opaque surface, the light sensor detects environmental light and activates the alarm, thereby aiding in prevention of theft

19. An illuminable three-dimensional shape as set forth in claim 1, wherein the light source is an LED light inserted into the illuminable translucent three-dimensional environment in order to illuminate the illuminable translucent three-dimensional environment.

20. An illuminable three-dimensional shape as set forth in claim 1, wherein the three-dimensional form is an athlete.

21. An illuminable three-dimensional shape as set forth in claim 20, wherein the athlete is selected from a group consisting of a surfer, a rock climber, a skier, a snowboarder, a skateboarder, an extreme biker, a backpacker, and a roller-blader.

22. An illuminable three-dimensional shape as set forth in claim 1, wherein the illuminable three-dimensional environment is an environment selected from a group consisting of a wave, a rock face, snow, a ramp, a mountain, and a sidewalk.

23. An illuminable three-dimensional shape as set forth in claim 1, wherein a combination of an athlete and the illuminable three-dimensional environment is selected from a group consisting of a surfer with a wave, a rock climber with a rock face, a skier with snow, a snowboarder with snow, a skateboarder with a ramp, an extreme biker with a ramp, a backpacker with a mountain, a roller-blader with a ramp, and a roller-blader with a sidewalk.

24. An illuminable three-dimensional shape as set forth in claim 1, wherein the light source includes a rotating color system, configured so that when activated, a color of the light source changes from one color into another color, thereby illuminating the illuminable translucent three-dimensional environment with another color.

25. An illuminable three-dimensional shape as set forth in claim 1, wherein the illuminable three-dimensional shape further comprises a means for storing and reproducing a sound stored therein, where the sound being produced corresponds to a theme of a combination of an athlete and the illuminable three-dimensional environment, thereby correlating audio data stored in the illuminable three-dimensional shape with the theme.

26. An illuminable three-dimensional shape as set forth in claim 1, wherein the illuminable three-dimensional shape further comprises an alarm clock incorporated therein having an alarm sound corresponding to a theme of a combination of an athlete and the illuminable three-dimensional environment, whereby when the alarm clock is actuated and an alarm is activated, the sound being produced corresponds with the theme of the illuminable three-dimensional shape.
